(19) United States
(12) Patent Application Publication
(10) Pub. No.: US 2026/0181340 A1
(43) Pub. Date: Jun. 25, 2026

(54) SPEECH ENHANCEMENT WITH ACTIVE MASKING CONTROL

(71) Applicant: LIZN ApS, Risskov (DK)

(72) Inventor: Niels Farver, Knebel (DK)

(21) Appl. No.: 19/126,137

(22) PCT Filed: Oct. 30, 2023
(86) PCT No.: PCT/DK2023/050256

§ 371 Date: Apr. 30, 2025

(30) Foreign Application Priority Data
Oct. 31, 2022 (DK) PA202270529

(51) Int. Cl. H04R 25/00

(52) U.S. Cl. CPC H04R 25/652

(57) ABSTRACT

A speech intelligibility enhancing system, and a method therefor, includes at least one in-ear headphone device arranged with an ear canal facing portion and an environment facing portion. The headphone device includes an acoustic path including a vent. The acoustic path couples the environment facing portion with the ear canal facing portion. An electroacoustic path includes a microphone at the environment facing portion, a filter, and a loudspeaker at the ear canal facing portion. The acoustic path is arranged to convey acoustic sound in a vowel dominated frequency range, and the electroacoustic path is arranged to acoustically reproduce sound signals in a consonant dominated frequency range and in the vowel dominated frequency range. The electroacoustic path is arranged such that a signal-to-masking ratio is improved by the electroacoustic path compensating contributions from the acoustic path in the vowel dominated frequency range.

### RELATED APPLICATIONS

This application claims priority to PCT Application No. PCT/DK2023/050256, filed Oct. 30, 2023, which claims priority to DK Patent Application No. PA 2022 70529, filed Oct. 31, 2022, the contents of each of which is incorporated herein by reference.

### FIELD OF THE INVENTION

The present invention relates to a speech intelligibility enhancing system for difficult acoustical conditions and a method for enhancing speech intelligibility in difficult acoustical conditions.

### BACKGROUND OF THE INVENTION

It is a common experience that speech communication in noisy environments is difficult. Especially cocktail parties, cafés and similar situations pose a challenge because the signal (the speech of a conversation partner) is very similar and often less loud than the noise (the babble of other people). A lot of mental effort is required of a person with normal hearing to discriminate words, and even more is required from a person with even a very mild hearing loss.

Many noise-suppressing algorithms (including adaptive microphone directional patterns) exhibit substantial gains in the signal-to-noise-ratio (SNR). However, they often fail to deliver better speech recognition scores in practical tests, for example due to processing artifacts and unnatural sounds.

Traditional passive hearing protectors generally attenuate too much, in particular at higher frequencies, making speech recognition even worse. Further, the traditional hearing protectors cause occlusion (i.e. the user perceives “hollow” or “booming” sounds of their own voice due to the blocking of the ear canal with no compensation).

So-called musician's earplugs aimed at attenuating a broad audio frequency band relatively equally to not distort music perception also generally attenuate too much to be useful for listening in noisy environments. They also often do not handle the occlusion effect.

Hearing aids, on the other hand, are aimed at improving audibility by using a general measure of sound amplification. This will often not be helpful for normal hearing or near-normal hearing persons having difficulties understanding speech in a noisy environment, as described above. To allow the user to engage in conversation, most hearing aids incorporate a vent to allow bone/tissue conducted sounds from the user's own voice to escape the ear canal, but this has the inherent problem that when the vent is large enough to provide acceptable perception of the user's own voice, a lot of low frequency energy from the surroundings enters the ear, gets amplified by the Helmholtz resonance and masks important higher frequency speech cues. To counteract this masking effect, the high frequency gain has to be increased. This, in turn, means that the overall level at the eardrum is increased above the level that would have resulted in the open ear. However, when the level is increased above a certain level (for normal hearing subjects, corresponding to around 65 dBA outside the ear), which is well below the levels present at a typical party, frequency discrimination and speech comprehension decline.

An ear device addressing one or more of the above-mentioned challenges to improve listening comfort and/or speech recognition in noisy environments for normal hearing or near-normal hearing persons would be highly advantageous and useful.

### SUMMARY OF THE INVENTION

The inventors have identified the above-mentioned problems and challenges in particular related to listening comfort and intelligibility of conversations in noisy environments, and subsequently made the below-described invention.

An aspect of the invention relates to a speech intelligibility enhancing system for difficult acoustical conditions, the speech intelligibility enhancing system comprising at least one in-ear headphone device for insertion in an ear canal of a person, the at least one in-ear headphone device being arranged with an ear canal facing portion and an environment facing portion, and the at least one in-ear headphone device comprising:
an acoustic path comprising a vent, the acoustic path coupling the environment facing portion with the ear canal facing portion; and
an electroacoustic path comprising a microphone at the environment facing portion, a filter and a loudspeaker at the ear canal facing portion;
   wherein the acoustic path is arranged to convey acoustic sound in a vowel dominated frequency range, and wherein the electroacoustic path is arranged to acoustically reproduce sound signals in a consonant dominated frequency range and in the vowel dominated frequency range; and
   wherein the electroacoustic path is arranged such that a signal-to-masking ratio is improved by the electroacoustic path compensating contributions from the acoustic path in the vowel dominated frequency range.

Thereby is provided an advantageous system for enhancing speech intelligibility in difficult acoustic environments. The advantages of the system will become clear throughout the following.

In the present context, speech is understood as a vocal communication using languages, such as non-tonal languages. Each language uses phonetic combinations of vowel and consonant sounds that form the sound of its words. Vowels tend to be lower in frequency and louder than the consonants, thus bearing a major part of the sound energy attributed with speech. However, it is actually the lower energy, and higher frequency, consonants which carry the majority of meaning of words. Thus, the intelligibility of speech is highly dependent on the frequency range of speech attributed with consonants. Consonants, in comparison to vowels, are more sensitive to upward spread of masking, and thus energy from vowels may impose a masking effect on the consonants. Such a masking effect is easy to relate to as it may occur when listening to a person speaking in a loud acoustic environment, for example in a café with a high level of background noise. To overcome the high level of background noise, people have a tendency to speak loudly and with more effort in order to be heard, a phenomenon often referred to as the Lombard effect. Speaking loudly has a profound effect on other persons intelligibility, as the added acoustic energy is concentrated around the vowels, i.e., in the vowel dominated frequency range, whereas only very little energy can be added to the consonants, i.e., in the consonant dominated frequency range. Thus, in a social setting, everybody speaks louder which means that a lot of energy is added in the vowel dominated frequency range. This basically means that consonants will be masked by the vowels which in turn makes it harder to understand what is being the. However, the importance of vowels in speech should not be underestimated, and they still play an important role in speech intelligibility.

In the present context a signal-to-masking ratio is understood as a measure that compares the level of a desired signal to the level of a masking signal. In this context, the desired signal is a signal that is substantially present in the consonant dominated frequency range, and the masking signal is a signal that is substantially present in the vowel dominated frequency range. In other words, the signal-to-masking ratio may also be referred to as a consonant-to-vowel ratio. The masking signal may not necessarily represent unwanted sound as is typical for a noise signal when discussing signal-to-noise ratios, however, the masking signal may actually include speech cues helpful for speech intelligibility. For example, the masking signal may comprise sound contributions by a speaker of interest (a person speaking to the person wearing the speech intelligibility enhancing system) and sound contributions made by a plurality of other people present in the same acoustic environment as the speaker of interest and the wearer of the speech intelligibility enhancing system (this sound contribution may be referred to as babble noise throughout the following disclosure). The point is that the masking signal imposes a masking effect on consonants in the consonant dominated frequency range, and therefore, by improving the signal-to-masking ratio, the masking effect may be reduced, and speech intelligibility improved. It should thus be noted that the speech intelligibility enhancing system is thereby effectively arranged to perform active masking control.

It should also be noted that the preceding discussion concerning improving signal-to-masking ratio should be construed as improving in light of a situation where the user is not wearing the speech intelligibility enhancing system, i.e., in light of the situation where the at least one in-ear headphone device (such as two in-ear headphone devices) are not inserted in an ear canal of the user.

According to an embodiment, improving the signal-to-masking ratio comprises increasing a resulting sound pressure level present in the consonant dominated frequency range with respect to a resulting sound pressure level present in the vowel dominated frequency range.

The improvement of the signal-to-masking ratio, or consonant-to-vowel ratio, may include increasing a resulting sound pressure level in the consonant dominated frequency range with respect to a resultant sound pressure level present in the vowel dominated frequency range. This may include amplification of acoustic sound present in the consonant dominated frequency range, i.e., that the electroacoustic path is arranged to perform sound amplification in the consonant dominated frequency range.

However, this should not be construed in such a way that the improvement of the signal-to-masking ratio is only achieved by adjusting a gain of the electroacoustic path in the consonant dominated frequency range, as the electroacoustic path is still arranged to compensate contributions by the acoustic path in the vowel dominated frequency range. Increasing a resulting sound pressure level present in the consonant dominated frequency range with respect to a resulting sound pressure level present in the vowel dominated frequency range is advantageous in that the effect of the masking signal on the signal of most interest to speech intelligibility, i.e., signals in the consonant dominated frequency range, is reduced, and thereby speech intelligibility may be improved.

According to an embodiment, the improving the signal-to-masking ratio comprises reducing a difference between a resulting sound pressure level in the ear canal contributed by the vowel dominated frequency range and a resulting sound pressure level in the ear canal contributed by the consonant dominated frequency range by compensating contributions from the acoustic path in the vowel dominated frequency range using the electroacoustic path.

The speech intelligibility enhancing system according to the present embodiment is advantageous in that it reduces the difference between sound pressure level (SPL), contributed by a vowel dominated frequency range, and the SPL, contributed by a consonant dominated frequency range. Sound pressure level is the most commonly used indicator of acoustic wave strength and is typically measured in decibels (dB). The reduction in difference of sound pressure level is performed by compensating contributions from an acoustic path using an electroacoustic path. An aim of the compensation is not to cancel out contributions from the acoustic path entirely, since the vowel content of speech contributed by the acoustic path is still important in the reproduction of speech in the ear canal of the person wearing the in-ear headphone device. Without vowel content contributed by the acoustic path, the speech, as experienced by the wearer of the at least one in-ear headphone device, would sound unnatural and lacking important features. However, an aim of the compensation is to reduce the impact of the high-energy vowels relative to the impact of the lower-energy consonants. Thereby, the consonant dominated part of speech may be promoted with respect to the vowel dominated part of speech, thus improving intelligibility of speech in many acoustic environments.

Put in another way, the effect of the compensation is that the total transfer function from the external acoustic environment to the ear canal, which is resultant from contributions by both the acoustic path and the electroacoustic path, exhibits a smaller difference between a sound pressure level of the vowel dominated frequency range and the sound pressure level in the consonant dominated frequency range compared to the difference between these in the case where no compensation is applied.

According to embodiments of the invention, the reduction in difference is obtained by compensating contributions from the acoustic path by use of a filter implemented in the signal processor. The signal processor may apply a filtering to a signal recorded by the microphone, and thereby provide a filtered signal for reproduction using the loudspeaker. The effect of the acoustic reproduction of the filtered signal is that the effect of acoustic sound contributed by the acoustic path, in a sub-range, or full range, of the vowel dominated frequency range is attenuated.

In the present context, a vowel dominated frequency range is understood as a range of frequencies which is substantially dominated by the presence of frequency components that are forming part of vowels. Furthermore, in the present context, a consonant dominated frequency range is understood as a range of frequencies dominated by the presence of frequencies that are forming part of consonants. A skilled person will readily appreciate that a clear line cannot be drawn between the frequency components of vowels and frequency components of consonants, as any tone generated by a human may comprise a plurality of harmonics including a first harmonic (or fundamental) and second-, third-, fourth-harmonics, etc. (or overtones), and an overtone of a frequency component of a vowel may exist in a higher frequency range, such as in a consonant dominated frequency range. However, a skilled person in phonetics will appreciate that frequency components of consonants are typically present at higher frequencies (such as from 2 kHz to 4 kHz) than frequency components making up vowels which are typically present at lower frequencies (such as in the range from 50 Hz to 1 kHz).

The at least one in-ear headphone device, such as two in-ear headphone devices, of the speech intelligibility enhancing system (or “system” in the following) is arranged to be inserted into an ear canal of a person. When inserted in the ear canal, the in-ear headphone device has a portion that is facing towards the ear canal—the “ear canal facing portion”- and a portion facing the other way towards the environment surroundings of the person—the “environment facing portion”. These two portions of the in-ear headphone device are coupled by way of the presence of an acoustic path. The acoustic path is understood as a path along which acoustic sound may propagate. The acoustic path comprises a vent, which is a channel or a duct having a specific geometry which may be dictated by acoustic concerns. The vent effectively couples the environment facing portion with the ear canal facing portion ensuring that acoustic sound present in the environment may propagate into the ear canal of the person. The acoustic path is arranged in such a way that acoustic sound of a specific range of frequencies may propagate through the acoustic path whereas acoustic sound of other frequencies may be hindered. These acoustic properties may be attributed to geometries (shape, cross sectional area, length) of the vent. Typically, in prior art systems, such as in-ear headphone devices for listening to music, such vents are used for reducing the impact of the occlusion effect on the listening experience. However, as will be clear in the following, the presence of a vent serves another purpose, namely acoustic reproduction of sound in the ear canal of the person. Nonetheless, an advantageous effect of the presence of the vent is that the acoustic path may reduce the impact of the occlusion effect on the experience of the wearer's own voice.

In addition to having an acoustic path comprising a vent, the in-ear headphone device also comprises an electroacoustic path comprising a microphone at the environment facing portion, a filter and a loudspeaker at the ear canal facing portion.

By means of such an electroacoustic path, sound from the external acoustic environment may be processed electronically, for example digitally, and reproduced in the ear canal.

The speech intelligibility enhancing system is furthermore advantageous in that it may effectively provide multi-band (such as two-band) dynamic range compression thereby facilitating different compressions in vowel dominated ranges and consonant dominated ranges.

The speech intelligibility enhancing system is furthermore advantageous in that it may, at least to some degree, provide a natural reproduction of acoustic sounds in an external environment. This effect is at least provided by the acoustic path which facilitates a natural reproduction in the ear canal of sounds present in the external acoustic environment.

An in-ear headphone device may be understood as a headphone device arranged to be worn by a user by fitting the device in the user's outer ear, such as in the concha, next to the ear canal. The in-ear headphone device may further extend at least partially into the ear canal of the user. The in-ear headphone device may typically be shaped to fit at least partly within the outer ear and/or the ear canal, thereby ensuring fitting of the device to the user's ear. An in-ear headphone device may also be understood as an in-ear headphone, ear-plug, in-the-canal headphone, an earbud or a hearable.

According to an embodiment, the consonant dominated frequency range comprises frequencies above the vowel dominated frequency range.

The consonant dominated frequency range may comprise frequencies above the vowel dominated frequency range. Irrespective of whether an overlap between the consonant dominated frequency range and the vowel dominated frequency range exists, the consonant dominated frequency range may still comprise frequencies that are not present in the vowel dominated frequency range, and these frequencies are above the vowel dominated frequency range. From this, it is clear that the consonant dominated frequency range is a frequency range relating to higher frequencies than the vowel dominated frequency range.

According to an embodiment, the acoustic path is arranged with an acoustic transfer function having a low-pass characteristic with a pass-band and a cutoff frequency, and wherein the vowel dominated frequency range comprises frequencies below the cutoff frequency, and wherein the consonant dominated frequency range comprises frequencies above the cutoff frequency.

The acoustic path may be arranged in such a way that it has an acoustic transfer function having a low-pass characteristic with a pass-band and a cutoff frequency, wherein the vowel dominated frequency range comprises frequencies below the cutoff frequency, and wherein the consonant dominated frequency range comprises frequencies above the cutoff frequency. By implementing such a low-pass characteristic in its transfer function, the acoustic path is arranged to let acoustic sound with a frequency below the cutoff frequency (in the pass-band) to pass through and reach the ear canal of the user wearing the at least one in-ear headphone device. However, acoustic sound having a frequency above the cutoff frequency is severely restricted in passing through the acoustic path. A skilled person in acoustics will readily appreciate that acoustic sound of higher frequency than the cutoff frequency may pass along the acoustic path, however, it is severely impeded. Usually, the cutoff frequency is a frequency at which an attenuation by 3 dB occurs. The vowel dominated frequency range comprises frequencies below the cutoff frequency and the consonant dominated frequency range comprises frequencies above the cutoff frequency, however this does not exclude the possibility of the vowel dominated frequency range also comprising frequencies above the cutoff frequency, and the consonant dominated frequency range comprising frequencies below the cutoff frequency.

According to an embodiment, the cutoff frequency is within the range from 250 Hz to 4 kHz.

The cutoff frequency may be in the range from 250 Hz (hertz) to 4 kHz (kilohertz), such as from 500 Hz to 2 kHz, such as from 650 Hz to 1600 Hz, such as from 700 Hz to 1200 Hz, for example 800 Hz, 900 Hz or 1 kHz.

According to an embodiment, the vowel dominated frequency range comprises frequencies in the range from 50 Hz to 1 kHz.

The vowel dominated frequency range may comprise frequencies in the range from 50 Hz to 1 kHz, such as frequencies in the range from 400 Hz to 800 Hz, for example 600 Hz.

According to an embodiment, the consonant dominated frequency range comprises frequencies in the range from 2 kHz to 4 kHz.

According to an embodiment, the difference is below 15 dB, such as below 10 dB, such as below 8 dB, such as below 6 dB, for example below 5 dB.

The difference between the sound pressure level in the ear canal contributed by the vowel dominated frequency range and the resulting sound pressure level in the ear canal contributed by the consonant dominated frequency range, after compensation, may be below 15 dB (decibels), such as below 10 dB, such as below 8 dB, such as below 6 dB, for example below 5 dB.

Reducing the difference between the sound pressure level contributed by the vowel dominated frequency range and the sound pressure level contributed by the consonant dominated frequency range, such that the difference is below 15 dB is to be regarded as a mere reduction of the impact provided by the acoustic path on the listening experience, and not as a full elimination of the impact provided by the acoustic path. In the present context, the acoustic sound propagating through the acoustic path is not to be regarded as unwanted sound, and quite to the contrary, the acoustic sound propagating through the acoustic path from the environment facing portion of the in-ear headphone device to the ear canal facing portion of the in-ear headphone device may contribute to speech intelligibility.

According to an embodiment, the electroacoustic path is arranged to compensate contributions from the acoustic path in a signal processing frequency range of 300 Hz to 1 kHz.

The electroacoustic path may be arranged to compensate contributions from the acoustic path in a signal processing frequency range by use of the signal processor. The signal processing frequency range may be a frequency range of 300 Hz to 1 kHz, such as a frequency range of 400 Hz to 800 Hz, for example 600 Hz.

According to an embodiment, the compensation of contributions from the acoustic path is signal dependent.

By signal dependent is at least understood that the signal processing, i.e., the compensation, is dependent on acoustic signals present in the external acoustic environment. Such a signal dependent compensation is advantageous in that the speech intelligibility enhancing system may better adapt to the external acoustic environment and thereby provide an improved listening experience.

According to an embodiment, the compensation of contributions from the acoustic path is level dependent.

By level dependent is understood that the signal processing, i.e., the compensation is dependent on a sound pressure level, as measured in for example a vowel dominated frequency range, for example a center frequency of the vowel dominated frequency range. Such a dependence is advantageous in that the speech intelligibility enhancing system may better adapt to sound pressure levels present in the external acoustical environment. For example, if sound pressure levels in the external acoustical environment are low there may be fewer requirements of compensation to achieve a high level of speech intelligibility than if sound pressure levels are high. In such low sound pressure levels, the compensation may be kept at a low level, thereby affecting the acoustic sound contributed by the acoustic path less severely, e.g., through fewer distortions. Thereby is achieved an advantage that the quality of reproduction of acoustic sound is always as high as possible in the ear canal of the user wearing the at least one in-ear headphone device.

It is further noted that the device implementing any of the above provisions may be arranged to adapt the compensation intermittently according to changes in the external acoustic environment, including adjusting gain of transfer functions and even switching the compensation on and off. The device may additionally be arranged to perform other kinds of sound processing in accordance with other acoustic conditions. Such other types of processing may include low frequency amplification which may be advantageous in quiet conversation.

According to an embodiment, the electroacoustic path is arranged to compensate contributions from the acoustic path by reproducing sound signals in at least a part of the vowel dominated frequency range.

The electroacoustic path may be arranged to reproduce sound signals of the external acoustic environment in at least a part of the vowel dominated frequency range. This may for example include reproducing sound signals using a loudspeaker of the in-ear headphone device in such a way that a compensation of the contributions by the acoustic path is realized. The compensation may include reproducing a sound signal having opposite polarity or different phase than audio signals contributed by the acoustic path in at least the vowel dominated frequency range.

According to an embodiment, the electroacoustic path is arranged to reproduce sound signals in the at least part of the vowel dominated frequency range with a polarity opposite a polarity of the acoustic sound conveyed by the acoustic path. The effect of the compensation is that the perceived loudness of acoustic sound in the vowel dominated frequency range is reduced compared to the situation where the at least one in-ear headphone device is not inserted in the ear canal of the user/wearer.

According to an embodiment, the electroacoustic path is arranged to reproduce sound signals in the at least part of the vowel dominated frequency range by applying a phase shift to sound signals.

As the electroacoustic path comprises a microphone, or a plurality of microphones according to other embodiments, and a loudspeaker, the electroacoustic path may perform signal processing to recorded signals. The signal processing may include application of a phase shift to such signals. Thereby the electroacoustic path may be arranged to reproduce sound signals, originating from the external acoustic environment, in the ear canal of a user in at least a part of the vowel dominated frequency range by applying a phase shift. Application of a phase shift may result in the reproduced signal having a counteracting effect on audio signals transmitted from the external acoustic environment to the ear canal via the acoustic path and vent thereof.

According to an embodiment, the phase shift is above 90 degrees and below 270 degrees.

The applied phase shift may be above 90 degrees and below 270 degrees. The phase shift may be applied to any frequency in the vowel dominated frequency range, such as a center frequency of the vowel dominated frequency range, for example at a frequency of 600 Hz.

According to an embodiment of the invention, the microphone and the loudspeaker are wired oppositely with respect to positive and negative terminals.

According to an embodiment, the vent is a damped vent.

The vent may be a damped vent comprising one or more vent elements and one or more dampening elements. The damped vent may for example be a vent with a dampening cloth located at one or both ends of the vent, or a vent configured with an integrated dampening effect.

The addition of an undamped vent to an in-ear headphone device may suppress the occlusion effect when the in-ear headphone device is worn by a user but results in a Helmholtz resonance. By further adding a dampening element to the vent, whereby a damped vent is provided, the Helmholtz resonance, as well as the related distortions it may generate, can be removed.

According to an embodiment, the loudspeaker and the vent are acoustically separated inside the at least one in-ear headphone device.

According to an embodiment, the vent is arranged with a cross-sectional area equivalent to a cylinder with a diameter in a range from 1.5 mm to 3.5 mm, such as from 2.0 mm to 3.0 mm, for example 2.3 mm or 2.5 mm.

Preferred cross-sectional areas for the vent may for example be in the range from 1.8 mm² (square millimetres) to 9.6 mm², such as from 3.1 mm² to 7.1 mm², for example 4.2 mm² or 4.9 mm². The vent may have various cross-sectional shapes, such as circular, rectangular and semi-circular, and may have varying cross-sectional area along its length, or be combined by two or more vents or split vents, but may preferably be designed with dimensions that are equivalent to the above-stated dimensions of a cylindrical vent.

According to an embodiment, the vent is arranged with a length equivalent to a cylinder with a length in a range from 2.5 mm to 10 mm, such as from 3.5 mm to 9 mm, such as from 4.5 mm to 8 mm, for example 5 mm or 7 mm.

The vent may have various shapes along its length, and may be straight, curved or bend, and may be combined by two or more vents or split vents, but may preferably be designed with dimensions that are equivalent to the above-stated dimensions of a cylindrical vent.

According to an embodiment, the filter is arranged in a signal processor, such as a digital signal processor, of the at least one in-ear headphone device.

According to an embodiment, the at least one in-ear headphone device is battery powered, such as powered by a rechargeable battery.

According to an embodiment, the at least one in-ear headphone device comprises two in-ear headphone devices, one for each ear canal of the person, and wherein the two in-ear headphone devices are arranged to coordinate settings between them.

The speech intelligibility enhancing system may include two in-ear headphone devices, one for each ear canal of a person, the two devices being arranged to coordinate settings between them. Thereby is achieved a speech intelligibility enhancing system having the same advantages as described above and being suitable for use with both ears of the user at the same time. It should be noted that any effect and advantage described in relation to the at least one in-ear headphone device equally applies to both in-ear headphone devices of this embodiment.

According to an embodiment, the at least one in-ear headphone device comprises a feedback microphone at the ear canal facing portion.

The at least one in-ear headphone device of the speech intelligibility enhancing system may comprise a feedback microphone arranged at the ear canal facing portion of the at least one in-ear headphone device. A feedback microphone is advantageous in that it facilitates improved control of the sound processing performed by the electroacoustic path of the at least one in-ear headphone device. In particular the feedback microphone may be used to adapt feed-forward processing of the electroacoustic path. The feedback is furthermore advantageous in that it enables the speech intelligibility enhancing system to detect whether the user/wearer of the system is speaking and adapt the electroacoustic path accordingly to provide the user/wearer with a desirable impression of the wearer's own voice.

According to an embodiment, the electroacoustic path is arranged to compensate contributions from the acoustic path on the basis of input provided by the feedback microphone.

Compensating contributions from the acoustic path on the basis of input provided by the feedback microphone is advantageous in that improved control of the sound processing performed by the electroacoustic path of the at least one in-ear headphone device. Specifically, by basing the compensation on input provided by the feedback microphone may be ensured that the acoustic sounds present in the ear canal of the user when the at least one in-ear headphone device is inserted therein actually reflects the desired listening experience.

According to an embodiment, the microphone of the electroacoustic path is a directional microphone.

In a preferred embodiment of the invention, the microphone of the electroacoustic path of the at least one in-ear headphone device is a directional microphone. A directional microphone is understood as a microphone that is most sensitive in one or more directions. In other words, a directional microphone has a polar pattern other than omnidirectional. A skilled person will readily appreciate that such a directional microphone may be realized in numerous ways including use of multiple microphones arranged in a particular configuration, or by using a single microphone in conjunction with a plurality of microphone ports/ducts. A directional microphone is advantageous when implemented in the at least one in-ear headphone device as omnidirectional sound contributions, such as babble noise, may be suppressed relative to sound contributions having a more directional character, such as relevant speech by a speaker standing in front of the user/wearer of the speech intelligibility enhancing system. Thereby, speech intelligibility may be improved further.

According to an embodiment of the invention, the directional microphone has a hypercardioid characteristic.

According to an embodiment, the electroacoustic path of the at least one in-ear headphone device comprises a plurality of microphones.

According to an embodiment of the invention, the electroacoustic path of the at least one in-ear headphone device may comprise a plurality of microphones, such as two or microphones. The plurality of microphones may be arranged such that the at least one in-ear headphone device comprises a directional microphone and an omnidirectional microphone.

According to an embodiment, the electroacoustic path is arranged to amplify sound with a nominal gain in a passband of the electroacoustic path.

The electroacoustic path may be arranged to amplify sound with a nominal gain in a passband of the electroacoustic path, such as amplifying sound with a nominal gain throughout the entire passband of the electroacoustic path. This is advantageous in situations of low sound pressure levels where speech comprehension may be difficult.

Another aspect of the invention relates to a method for enhancing speech intelligibility in difficult acoustical conditions, the method comprising the steps of inserting at least one in-ear headphone device in an ear canal of a person, the at least one in-ear headphone device being arranged with an ear canal facing portion and an environment facing portion, the at least one in-ear headphone device comprising an acoustic path comprising a vent coupling the environment facing portion with the ear canal facing portion and an electroacoustic path comprising a microphone at the environment facing portion, a filter, and a loudspeaker at the ear canal facing portion; conveying acoustic sound in a vowel dominated frequency range from the environment facing portion to the ear canal facing portion by the acoustic path; acoustically reproducing sound signals in a consonant dominated frequency range and in the vowel dominated frequency range by the electroacoustic path; and compensating contributions from the acoustic path in the vowel dominated frequency range by the electroacoustic path such that a signal-to-masking ratio is improved.

Thereby is realized a method for enhancing speech intelligibility in difficult acoustical conditions. The method is advantageous for at least the same reasons given with respect to the above speech intelligibility enhancing system.

According to an embodiment, the method is carried out by a speech intelligibility enhancing device according to any of the previous provisions.

### THE DRAWINGS

Various embodiments of the invention will in the following be described with reference to the drawings where

FIG. 1 illustrates an in-ear headphone device of a speech intelligibility enhancing system according to an embodiment of the invention,

FIGS. 2a-2d illustrate various in-ear headphone devices according to embodiments of the invention,

FIGS. 3a-3h illustrate various layouts of a vent of an acoustic path suitable for use in an in-ear headphone device according to embodiments of the invention,

FIG. 4 illustrates properties of the acoustic path and the electroacoustic path according to embodiments of the present invention,

FIG. 5 illustrates a concept of compensating contributions from the acoustic path in the vowel dominated frequency range using the electroacoustic path,

FIGS. 6-16 illustrate spectra of sound signals present in a room, transfer functions of an in-ear headphone device according to an embodiment of the invention, and application of the transfer functions on the sound signals useful for understanding the present invention, and

FIG. 17 illustrates a speech intelligibility enhancing system according to an embodiment of the invention.

### DETAILED DESCRIPTION

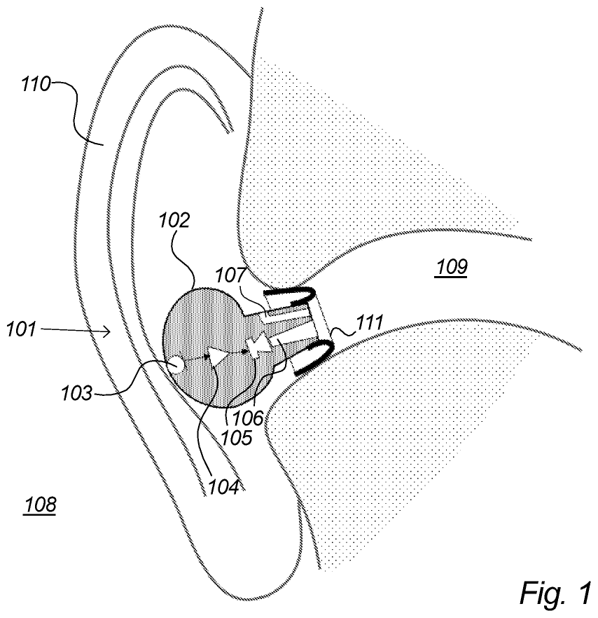

FIG. 1 illustrates a speech intelligibility enhancing system 101 according to an embodiment of the invention. The speech intelligibility enhancing system 101 is shown as comprising an in-ear headphone device 102, however, according to another embodiment, the speech intelligibility enhancing system 101 may comprise two in-ear headphone devices 102; one for each ear of a person. Thus, the following description relating to the in-ear headphone device 102 equally applies to a system comprising two in-ear headphone devices.

The illustration of FIG. 1 shows the in-ear headphone device 102 when inserted in an ear canal 109 of a person/user wearing the in-ear headphone device. The in-ear headphone device 102 preferably rests in the outer ear 110 of a user and is provided with a flexible ear tip 111 for providing acoustic sealing in ear canals 109 of different users.

The in-ear headphone device 102 comprises a microphone 103 arranged to record primarily acoustic sound from the external acoustic environment 108. In the drawing of this embodiment is shown that the microphone 103 is arranged at the external acoustic environment facing end of the in-ear headphone device 102, however, in other embodiments of the invention, the microphone 103 may be arranged further within the in-ear headphone device 102 and be acoustically coupled to the external acoustic environment 108 by a microphone duct (not shown in the figure). The in-ear headphone device further comprises a signal processor 104, in the form of a digital signal processor, configured to receive recorded audio signals from the microphone 103 and apply a filter thereto (a digital filter in this embodiment) to provide a filtered audio signal for acoustic reproduction using a loudspeaker 105 of the in-ear headphone device. In the drawing of this embodiment is shown that the loudspeaker 105 is contained within the in-ear headphone device 102 and acoustic sound emitted by the loudspeaker 105 is transmitted to the ear canal 109 via a loudspeaker duct 106. However, the loudspeaker duct 106 may, in other embodiments, be dispensed with and the loudspeaker 105 may be arranged closer to the ear canal facing end of the in-ear headphone device 102. The ensemble comprising the microphone 102, the signal processor 104, and the loudspeaker 105 is referred to as an electroacoustic path in the following.

In addition to the electroacoustic path, the in-ear headphone device 102 comprises an acoustic path comprising a vent 107. The vent is a narrow duct along which acoustic sound may propagate. The purpose of the vent is to facilitate transmission of low frequency acoustic sounds between the ear canal 109 and the external acoustic environment 108. In other words, the vent 107 facilitates a coupling of the environment facing portion of the in-ear headphone device 102 with the ear canal facing portion of the in-ear headphone device 102. The boundary between the ear canal facing portion and the environment facing portion of the in-ear headphone device 102 is at the circumference of the in-ear headphone device 102 where it generally is in contact with the ear canal 109, i.e., where it substantially plugs the ear canal.

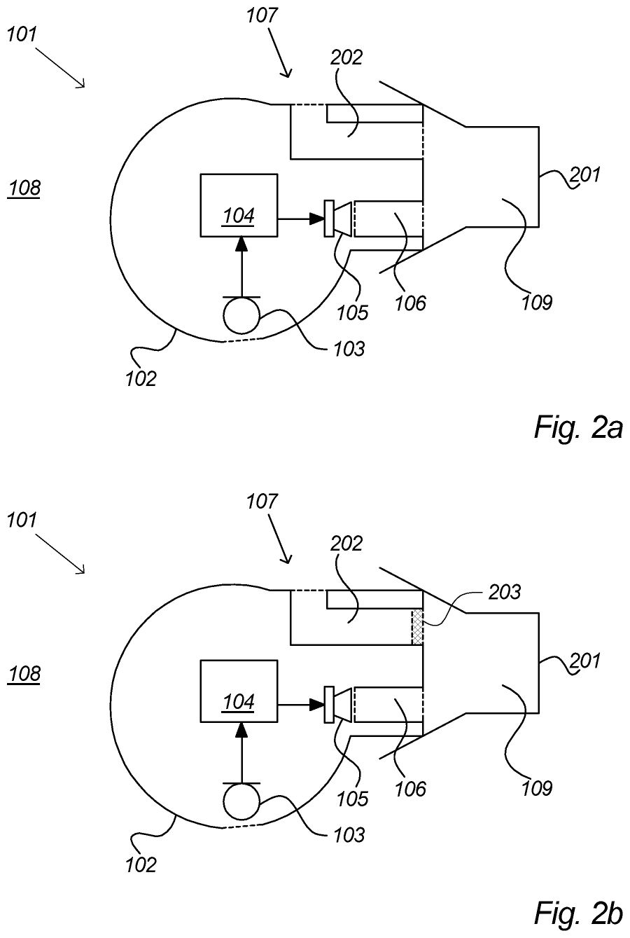

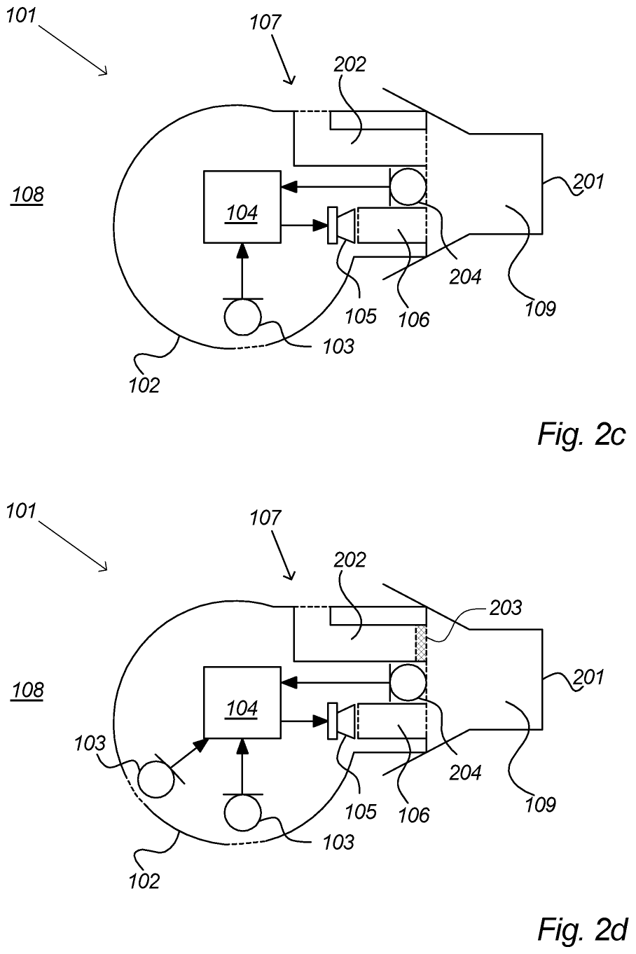

FIGS. 2a-2d illustrate various in-ear headphone devices 102 according to embodiments of the invention.

FIG. 2a shows the in-ear headphone device 102 of FIG. 1 also inserted into the ear canal 109 of a user according to an embodiment. As is clearly evident by the figure, acoustic sound present in the external acoustic environment 108 may propagate through the acoustic path of the in-ear headphone device 102, i.e., through the vent 107 and its vent element 202, and into the ear canal 109 of the user. Furthermore, acoustic sound present in the external acoustic environment 108 is picked up by the microphone 103, processed by the signal processor 104, acoustically reproduced by the loudspeaker 105, and the reproduced sound is channeled from the loudspeaker 105 to the ear canal 109 via the loudspeaker duct 106. From this it is clear that a total transfer function of sound from the external acoustic environment 108 and into the ear canal 109 comprises two contributions, namely the acoustic path and the electroacoustic path. Thus, sound picked up by the tympanic membrane (ear drum) 201 of the user is resultant from these contributions. As seen in this figure, the vent comprises a single vent element 202, in the form of a duct, however, as will be clear from the following description, other configurations of vents are possible according to other embodiments.

FIG. 2b shows a variation of the in-ear headphone device 102 as seen in FIG. 2a and is according to another embodiment. In this embodiment, the vent 107 is a damped vent which additionally comprises a damping element 203. The damping element according to the present embodiment is a damping cloth located at one end of the damped vent 107. In another embodiment the dampening characteristics of the damped vent 107 is provided by dampening cloth at both ends of the damped vent 107, and in other embodiments the dampening characteristics of the damped vent 107 is provided by slits or openings in the vent element 202.

FIG. 2c shows yet another variation of the in-ear headphone device 102 as seen in FIG. 2a and is according to another embodiment. In this embodiment, the in-ear headphone device comprises a feedback microphone 204 in addition to the microphone 103. The feedback microphone is shown as arranged right next to the ear canal facing portion of the in-ear headphone device 102, however, according to other embodiments, the feedback microphone 204 may be arranged further towards the center of the interior of the in-ear headphone device 102 and may be acoustically coupled with the ear canal 109 via a microphone duct (not shown in the figure). The feedback microphone 204 is arranged to pick up acoustic sound in the ear canal 109 and feed recorded signals to the signal processor 104. Specifically, the feedback microphone may detect sound pressure levels throughout a range of frequencies including at least low frequencies, such as frequencies in the range of 50 Hz to 1 kHz (an example of a vowel dominated frequency range), and higher frequencies, such as frequencies in the range of 2 kHz to 4 kHz (an example of a consonant dominated frequency range). Typically, such a microphone will be configured to detect at least the entire frequency range that is audible to a person (i.e., the hearing range), which is typically frequencies in the range from 20 Hz to 20 kHz.

FIG. 2d shows another embodiment which is a variation of the in-ear headphone device 102 as seen in FIG. 2c. As seen, the in-ear headphone device 102 comprises a damped vent 107 comprising a vent element 202 and a dampening element 203, similar to the damped vent 107 described in relation to FIG. 2b. In another embodiment the dampening characteristics of the damped vent 107 is provided by dampening cloth at both ends of the damped vent 107, and in other embodiments the dampening characteristics of the damped vent 107 is provided by slits or openings in the vent element 202.

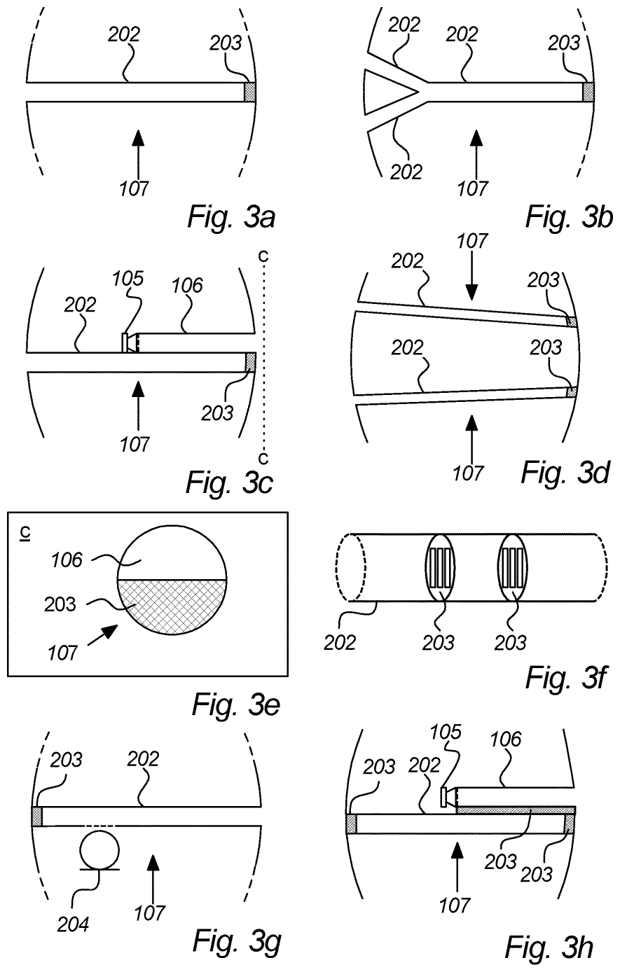

FIGS. 3a-3h illustrate various layouts of a vent 107 of an acoustic path suitable for use in an in-ear headphone device 102 according to embodiments of the invention. It should be noted that throughout the figures, a damped vent is illustrated, however, all the illustrated vents may also be used without dampening elements according to other embodiments of the invention.

FIG. 3a shows a sideview of a damped vent 107 according to an embodiment of the invention. The damped vent 107 comprises a vent element 202 in the form of a cylinder and a dampening element 203 in the form of a damping cloth. Although the vent element 202 is illustrated as a cylindrical element in this embodiment, other geometries are also conceivable.

The dampening element 203 in the form of a damping cloth is illustrated as being located at one end of the vent element 202, however, it may be positioned in any end of the vent element 202, and in another embodiment of the invention the damped vent 107 comprises dampening elements 203 in both ends of the damped vent 107.

The dampening element 203 of the present embodiment is positioned within an opening of the vent element 202, however, in another embodiment of the invention the dampening element 203 may be positioned in such a way that it covers the opening of the vent element 202.

FIG. 3b shows a sideview of a damped vent 107 according to an embodiment of the invention. Several vent elements 202 forms a branched damped vent 107 which further comprises a dampening element 203 in the form of a damping cloth. The dampening element 203 of the present embodiment is positioned within an opening of the vent element 202, however, in another embodiment of the invention the dampening element 203 may be positioned in such a way that it covers the opening of the vent element 202. Furthermore, in other embodiments of the invention, the branched damped vent may comprise any number of dampening elements 203, such as dampening elements 203 covering all of the openings of vent elements 202.

FIG. 3c-3d shows two side views of a damped vent 107 according to embodiments of the invention. FIG. 5c shows a damped vent 107 which is built together with a loudspeaker duct 106, to which the loudspeaker 105 may be acoustically coupled. In this embodiment of the invention, the loudspeaker duct 106 and the damped vent 107 constitutes a cylindrical acoustic tube, i.e., each of the two has a half-cylindrical geometry. In other embodiments of the invention, the loudspeaker duct 106 and the damped vent 107 may constitute a combined acoustic tube having any geometric shape. In FIG. 3c a dashed line c-c is shown which represents a plane c. In FIG. 3e, a view of the embodiment from the plane c is illustrated, showing a longitudinal geometry of the combined loudspeaker duct 106 and damped vent 107.

FIG. 3d illustrates an embodiment of the invention in which the in-ear headphone device 102 (not shown in the figure) comprises two separate damped vents 107. Each damped vent 107 is similar to the damped vent 107 as shown in relation to the embodiment of FIG. 3a. Likewise, the configuration of damped vents 107 in FIG. 3d comprises vent elements 202 and dampening elements 203. The dampening elements 203 of this embodiment are damping cloth present in openings of the vent elements 202, however other configurations of dampening elements are also conceivable.

FIG. 3f illustrates an embodiment of the invention in which the damping characteristics of the damped vent 107 is facilitated by dampening elements 203 which takes the form of slits. In another embodiment, dampening elements 203 are integrated into the vent element 202, e.g. to disturb air flow or facilitate air leakage.

FIG. 3g illustrates an embodiment of the invention, in which a microphone, for example the feedback microphone 204, is arranged to primarily record sound from the damped vent 107. The microphone may thus be considered acoustically coupled to a vent element 202 of the damped vent 107 within the in-ear headphone device 102. In other embodiments, the in-ear headphone device 102 comprises several vent elements 202, and a microphone and/or a loudspeaker may be coupled to any of these vent elements 202 according to embodiments of the invention. In the embodiment shown in FIG. 3g, the damped vent 107 has a single dampening element 203 at one side. In such embodiments, the microphone may thus primarily record sound from an external environment, or primarily record sound from the ear canal, depending on the exact positioning of the dampening element 203 and the microphone.

FIG. 3h illustrates an embodiment of the invention in which a loudspeaker duct 106 and the damped vent are partially coupled by a dampening element 203. The damped vent 107 also further comprises dampening elements 203 at both ends of a vent element 202. The loudspeaker duct 106 and the damped vent 107 may feature any type of partitioning according to embodiments of the inventions. The loudspeaker 105 may for example be acoustically coupled to the damped vent 107 within the in-ear headphone device 102, be acoustically decoupled with the damped vent 107 within the in-ear headphone device 102 (see e.g. FIG. 3c), or be partially coupled with the damped vent 107 within the in-ear headphone device 102, as illustrated in FIG. 3h.

In the above described embodiments of the invention, various configurations of damped vents 107 are demonstrated. However, the invention is not restricted to any specific configuration and various other embodiments are thus available to a skilled person. The damped vent configuration may be realized by any combination of the above described embodiments; thus, the damped vent configuration may comprise one or more damped vents 107, individual damped vents may comprise any number of vent elements 202 and dampening elements 203, microphones and/or loudspeaker may be acoustically coupled to vent elements or may have individual ducts, and vent and ducts may have any geometric shape. Furthermore, as already mentioned, all the vents shown in FIGS. 3a-3h can be used without dampening elements 203 according to other embodiments of the invention.

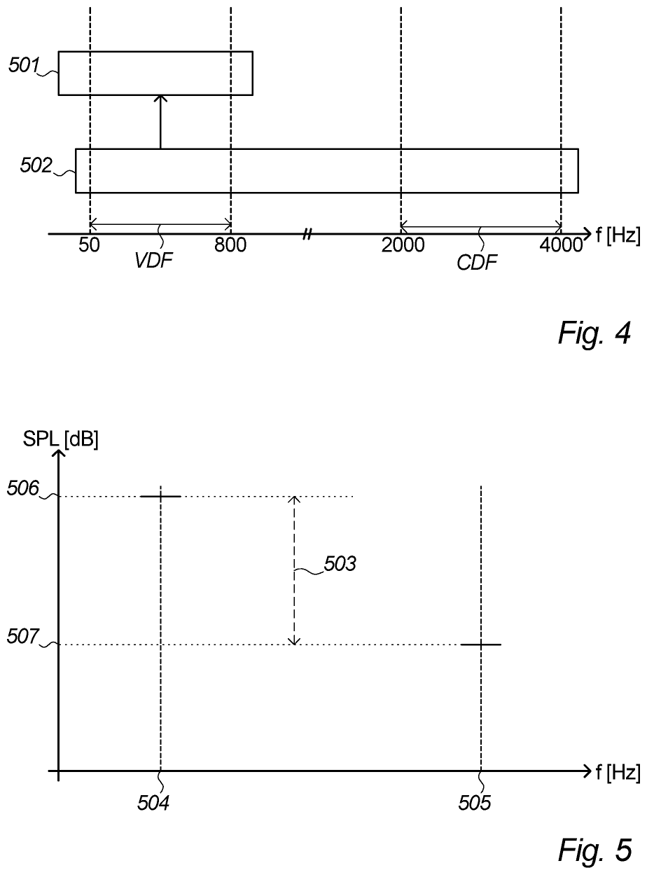

FIG. 4 illustrates properties of the acoustic path 501 and the electroacoustic path 502 according to embodiments of the present invention. The figure shows a horizontal axis representing frequency (f) in units of hertz (Hz). As seen in the figure, the frequency axis includes two frequency ranges, a vowel dominated frequency range VDF and a consonant dominated frequency range CDF. The vowel dominated frequency range VDF comprises frequencies in the range from 50 Hz to 800 Hz, and the consonant dominated frequency range comprises frequencies in the range of 2000 Hz (2 kHz) to 4000 Hz (4 kHz). Although the two frequency ranges are illustrated as two distinct ranges, this does not preclude that signal content relating to vowels may exist outside the vowel dominated frequency range VDF, and that signal content relating to consonants may exist outside the consonant dominated frequency range CDF. In the present context, the consonant dominated frequency range CDF is taken to comprise frequencies above the frequencies contained in the vowel dominated frequency range VDF. In a situation with party noise or similar, the majority of the noise energy falls within the vowel dominated frequency range VDF. The figure also illustrates the passbands of the acoustic path 501 and the electroacoustic path 502 of the in-ear headphone device 102. The acoustic path 501 comprises at least a vent 107 (see for example FIG. 1), and the electroacoustic path 502 comprises at least a microphone 103, a signal processor 104, and a loudspeaker 105. The acoustic path 501 may be any acoustic path previously described, and the electroacoustic path 502 may be any electroacoustic path previously described. As seen, the acoustic path 501 is focused on the vowel dominated frequency range VDF. The acoustic path 501 is effectively a low pass filter where the vowel dominated frequency range VDF is within a passband of the acoustic path 501. The electroacoustic path 502, however, processes a much wider frequency range than the acoustic path 501 and encompasses both the vowel dominated frequency range VDF and the consonant dominated frequency range CDF. FIG. 4 also illustrates a vertical arrow extending from the electroacoustic path 502 to the acoustic path 501 within the vowel dominated frequency range VDF. The arrow is representative of a compensation being performed by the electroacoustic path 502. This compensation is best understood by considering FIG. 5.

FIG. 5 illustrates a concept of compensating contributions from the acoustic path 501 in the vowel dominated frequency range VDF using the electroacoustic path 502. Speech includes both vowels and consonants, and speech intelligibility is to a great extent attributed to the correct detection of consonants. In many situations though, such as the cocktail party situation, the vowels from competing speakers, which carry the bulk of the sound energy of speech, has a masking effect on the consonants of the conversation partner. Put in other words, signal content in the vowel dominated frequency range VDF may impose a masking effect on signal content present in the consonant dominated frequency range CDF. For this reason, the in-ear headphone device of the speech intelligibility enhancing system (see for example in-ear headphone devices of FIGS. 1 and 2a-2d), is arranged such that a difference 503 between a resulting sound pressure level in the ear canal 109 contributed by the vowel dominated frequency range VDF and a resulting sound pressure level in the ear canal 109 contributed by the consonant dominated frequency range CDF is reduced by compensating contributions from the acoustic path 501 in the vowel dominated frequency VDF range using the electroacoustic path 502. FIG. 5 illustrates a resulting sound pressure level (SPL) 506 contributed by the vowel dominated frequency range VDF and a resulting sound pressure level 507 contributed by the consonant dominated frequency range. As seen in the present embodiment, the resulting sound pressure level 506 contributed by the vowel dominated frequency range is present at a center frequency 504 of the vowel dominated frequency range VDF and the resulting sound pressure level 507 contributed by the consonant dominated frequency range is present at a center frequency 505 of the consonant dominated frequency range CDF. However, in other embodiments, the resulting sound pressure levels may represent average sound pressure levels of the entire vowel dominated frequency range and consonant dominated frequency range, or average sound pressure levels of sub-ranges thereof. The difference 503 between the two resulting sound pressure levels is seen in FIG. 5. In a preferred embodiment, the difference 503 is maintained below 15 dB, and in an even more preferred embodiment, the difference 503 is maintained below 10 dB. Such a maintenance may require that the difference 503 is reduced, and this is achieved by compensating contributions from the acoustic path 501 in the vowel dominated frequency range VDF using the electroacoustic path 502. Such a compensation may be achieved in multiple ways according to embodiments of the present invention. In the present embodiment, the signal processor 104 of the speech intelligibility enhancing system 101 is essentially arranged to apply a phase shift to signals recorded by the microphone 103, and thereby acoustically reproduce a phase shifted audio signal in the vowel dominated frequency range VDF using the loudspeaker 105.

Crucially, the phase-shifted audio signal has an opposing effect on the acoustic sound in the ear canal 109 contributed by the acoustic path 501, which effect ensures that the overall transfer function of sound from the external acoustic environment 108 to the ear canal 109 exhibits a characteristic where the difference 503 is below prescribed levels. More crucially, the compensation is not intended to completely oppose acoustic sound in the ear canal 109 contributed by the acoustic path 501, as it is still an objective to achieve some degree of natural reproduction of acoustic sound in the passband of the acoustic path 501. This is especially important since the vowels produced by the conversation partner are themselves speech cues and also establish time windows for when the crucial consonants may appear. Clearly, reducing the difference 503 as detailed above is a way of improving a signal-to-masking ratio.

In a preferred embodiment, the signal processing algorithm adjusts the amount of attenuation applied to the vowel dominated frequency range VDF according to the sound pressure level, so that sound is perceived with a natural and/or desired spectral balance when the low-frequency level is low enough that consonant masking is unlikely to occur.

In another preferred embodiment, the signal processing algorithm is arranged to detect when the wearer of the in-ear headphone device is speaking and adjust compensation so as to maintain a natural impression of the wearer's own voice.

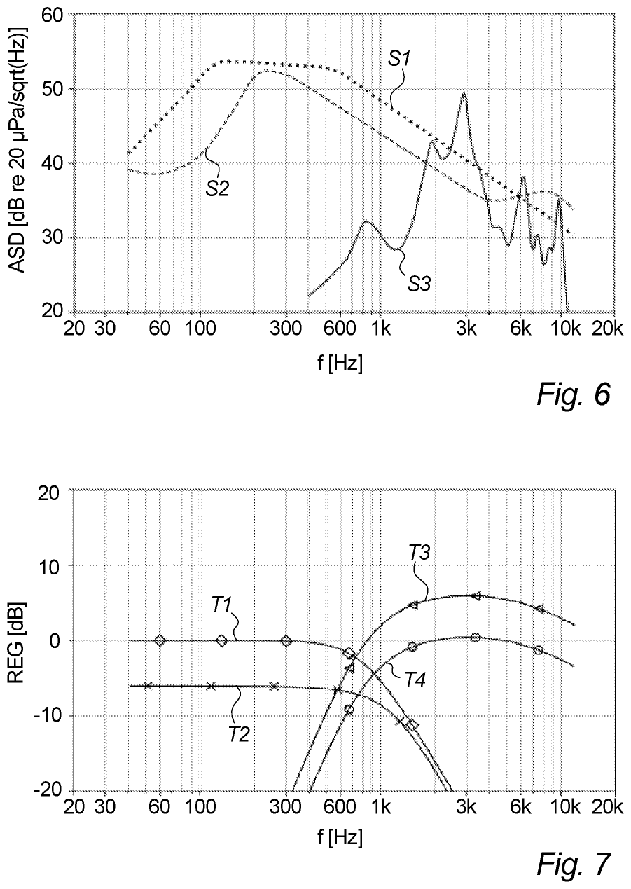

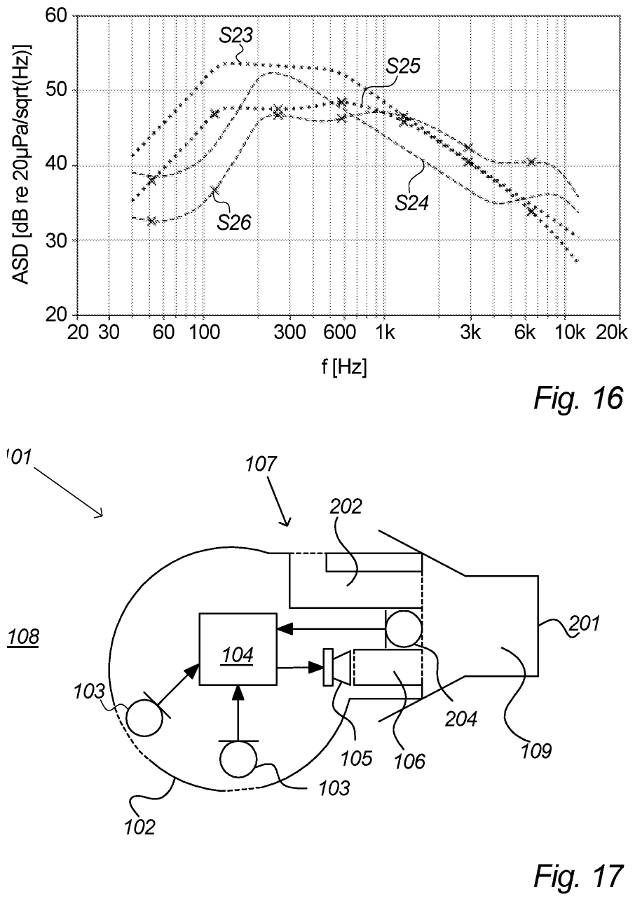

FIGS. 6-15 illustrate spectra relating to an in-ear headphone device 102 according to an embodiment of the invention as shown in FIG. 16. In this embodiment, the in-ear headphone device 102 of the speech intelligibility enhancing system 101 comprises two microphones. Further details on this embodiment are given in the text accompanying FIG. 16.

FIG. 6 illustrates the spectra of three signals as they appear in the absence of any baffle effects, i.e., as though one had recorded the signals using an omnidirectional microphone located at a position where the wearer of the speech intelligibility enhancing system 101 would be standing. The figure shows three signal curves S1, S2, and S3 plotted on a graph showing amplitude spectral density (ASD), in units of dB re 20 micropascal per square root of Hertz [dB re 20 μPa/sqrt(Hz)], as a function of frequency, in units of Hertz [Hz].

The signal curve S1 represents a long-term-average spectrum of noise present in a room where thirty people are talking. Throughout the following description, this will be referred to as babble noise.

The signal curve S2 also represents a long-term average spectrum of a single speaker located approximately one meter away from the wearer of the speech intelligibility enhancing system 101. Any speech pause made by the speaker has been left out from the integration leading to the signal curve S2.

The signal curve S3 represents a short-time-spectrum of the consonant “t” spoken by the single speaker located one meter away from the wearer of the speech intelligibility enhancing system 101. As seen, the spectra for the consonant “t” peaks at around 3 kHz, i.e., in a consonant dominated frequency range CDF. It should be noted that the consonant “t” has only been selected for the purpose of demonstration, and a skilled person would have knowledge of spectra for other consonants which could easily have been used instead and demonstrate the same principles as will be set out in the following.

The three signal curves S1, S2, and S3, together, demonstrate the typical cocktail party situation where intelligibility of speech is made difficult by the presence of babble noise which has a masking effect on the consonants crucial for speech intelligibility. The three signal curves S1, S2, and S3 may, in the following, be regarded as input signals to a signal processing by the acoustic path and the electroacoustic path of the at least one in-ear headphone device. This signal processing is demonstrated by the transfer functions of FIGS. 7-9.

FIG. 7 illustrates four simplified transfer functions T1 (squares), T2 (crosses), T3 (triangles), and T4 (circles). The transfer functions are simplified in the sense that they do not take into account ear canal resonances. The transfer functions are plotted on a graph showing real-ear-gain (REG), in units of decibel (dB), as a function of frequency, in the units of Hz. The transfer function T1 is a transfer function for the vent 107 of the acoustic path. In the following, this transfer function is referred to as the vent transfer function. The transfer function T2 is a transfer function of an audio signal recorded by one of the microphones of the in-ear headphone device, which in this case acts as a pressure microphone, e.g., an omnidirectional microphone. In the following, this transfer function is referred to as the omnidirectional microphone transfer function. The transfer function T3 is a transfer function of an audio signal recorded by one or more microphones of the in-ear headphone device, which acts as a directional microphone of the hypercardioid type. As the directional microphone is most sensitive in particular direction(s), it is less sensitive to acoustic sound of a more diffuse character such as babble noise. This is reflected by transfer function T4 which is a transfer function of the directional microphone when subjected to diffuse acoustic sound, e.g., babble noise. As seen by comparing transfer functions T3 and T4, the directional microphone effectively suppresses diffuse acoustic sound by about 5.5 dB compared to acoustic sound having a directional character. This illustrates that the directional microphone is more sensitive to a speaker standing in front of the wearer of the speech intelligibility enhancing system 101 than it is to the babble noise present in the room.

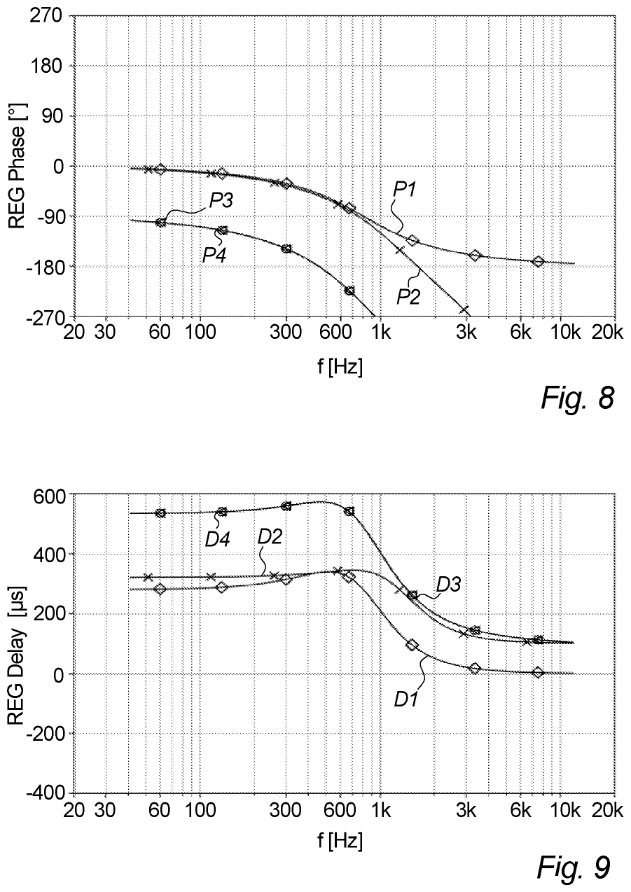

FIGS. 8 and 9 show the corresponding phase plots and delay plots of the transfer functions as seen in FIG. 7. In FIG. 8 is shown four phase curves P1 (squares), P2 (crosses), P3 (triangles), and P4 (circles), which phase curves corresponds to the four transfer functions T1, T2, T3, and T4, respectively. The graph in FIG. 8 shows the phase, in degrees, as a function of frequency, in units of Hz. In FIG. 9 is shown four group-delay curves D1 (squares), D2 (crosses), D3 (triangles), and D4 (circles), which phase curves correspond to the four transfer functions T1, T2, T3, and T4, respectively.

The graph in FIG. 9 shows the delay, in units of microseconds, as a function of frequency, in units of Hz. In order to illustrate that the invention according to the present embodiment can accommodate processing latency, a fixed delay of 100 microseconds has been added to the transfer functions of the electroacoustic path.

Having identified the types of acoustic sound signals present in a room during the cocktail party situation (see FIG. 6), and the transfer functions of the at least one in-ear headphone device 102 of the speech intelligibility enhancing system (see FIG. 7), the effects of applying the transfer functions to these signals are discussed with reference to the following figures.

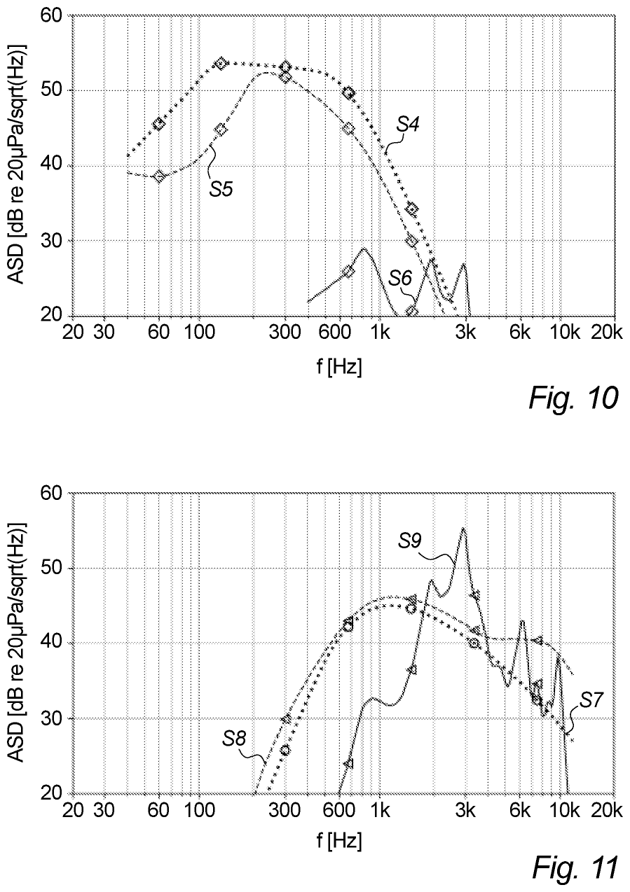

FIG. 10 illustrates the effect of applying the vent transfer function T1 to the three input audio signals represented by signal curves S1, S2, and S3. The graph in FIG. 10 shows amplitude spectral density (ASD) as a function of frequency in the same way as the graph in FIG. 6. The signal curve S4 shows the result of applying the vent transfer function T1 to the acoustic sound signal represented by signal curve S1. In other words, signal curve S4 shows the contribution of the vent/acoustic path to the babble noise present in the ear canal of a wearer of the in-ear headphone device 102. The signal curve S5 shows the result of applying the vent transfer function T1 to the acoustic sound signal represented by signal curve S2. In other words, signal curve S5 shows the contribution of the vent to the sound of a specific person speaking, in the ear canal of the wearer of the in-ear headphone device. The signal curve S6 shows the result of the applying the transfer function T1 to the acoustic sound signal represented by signal curve S3. In other words, signal curve S6 shows the contribution of the vent to the consonants, produced by the specific person speaking, present in the ear canal of the wearer of the in-ear headphone device. As seen in FIG. 10 the effect of the vent transfer function T1 is that consonants (in this case the consonant “t”) are suppressed when passing through the vent with respect to lower-frequency content.

FIG. 11 illustrates the effect of applying transfer function T3 to the three input audio signals represented by signal curves S1, S2, and S3. The graph in FIG. 11 shows amplitude spectral density (ASD) as a function of frequency in the same way as the graph in FIG. 6. The signal curve S7 shows the result of applying the transfer function T3 to the acoustic sound signal represented by signal curve S1. In other words, signal curve S7 shows the directional microphone's contribution to the babble noise present in the ear canal of a wearer of the in-ear headphone device 102. The signal curve S8 shows the result of applying the transfer function T3 to the acoustic sound signal represented by signal curve S2. In other words, signal curve S8 shows the directional microphone's contribution to the desired speech signal present in the ear canal of the wearer of the in-ear headphone device. The signal curve S9 shows the result of applying the transfer function T3 to the acoustic sound signal represented by signal curve S3. In other words, signal curve S9 shows the directional microphone's contribution to the consonant “t” present in the ear canal of the user wearing the in-ear headphone device.

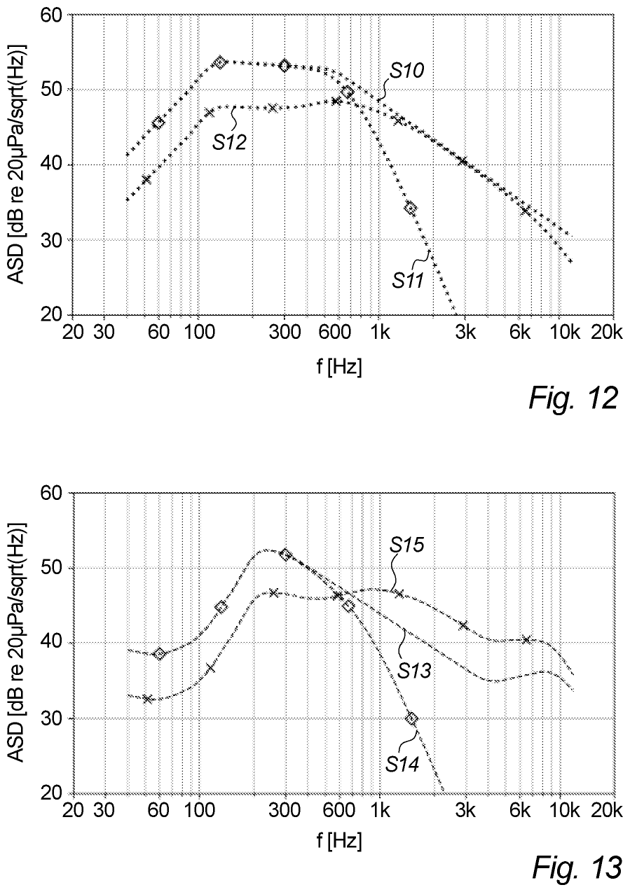

FIG. 12 is a graph also showing amplitude spectral density (ASD) as a function of frequency in the same way as the graph in FIG. 6. The graph shows three signal curves S10, S11, and S12. The signal curve S10 corresponds to the long-term average spectrum of babble noise equal to the signal curve S1 in FIG. 6. The signal curve S11 corresponds to signal curve S4 seen in FIG. 9, i.e., signal curve 11 shows the effect of applying the vent transfer function on the babble noise. When comparing signal curves S10 and S11 the effect of the vent of the acoustic path is clearly seen, particularly the inherent low-pass characteristic of the vent. Babble noise having the majority of its energy in the low frequencies, i.e., in the pass band of the vent, passes through the vent, whereas higher frequencies are clearly attenuated by the presence of the vent. It is also seen that the presence of the vent has not significantly reduced the amplitude spectral density for frequencies below 600 Hz.

The signal curve S12, however shows the resulting effect when the vent transfer function T1 and the omnidirectional microphone transfer function T2 (see FIG. 7) are applied to the babble noise signal S10 and combined in the ear canal. In essence, signal curve S12 represents the long-time average spectra of the babble noise present in the ear-canal of the user of the in-ear headphone device 102. As seen from the figure, the babble noise is significantly reduced compared to the babble noise in the absence of the in-ear headphone device (see signal curve S10). As can be seen with these example transfer functions, a reduction of about 6 dB is realized at 300 Hz.

FIG. 13 is a graph also showing amplitude spectral density (ASD) as a function of frequency in the same way as the graph in FIG. 6. Specifically, the graph shows three signal curves S13, S14, and S15. The signal curve S13 corresponds to the long-term average spectrum of a single speaker located approximately one meter away from the wearer of the speech intelligibility enhancing system 101, i.e., the signal curve S13 corresponds to signal curve S2 as seen in FIG. 6. Signal curve S14 shows the effect of applying the vent transfer function T1 to the long-time average spectrum of the speaker talking. Thus, signal curve S14 corresponds directly to signal curve S5 of FIG. 10. Signal curve S15 represents the resulting speech signal present in the ear canal of the user wearing the in-ear headphone device 102, and thereby represents contributions by the acoustic path and the electroacoustic path of the in-ear headphone device.

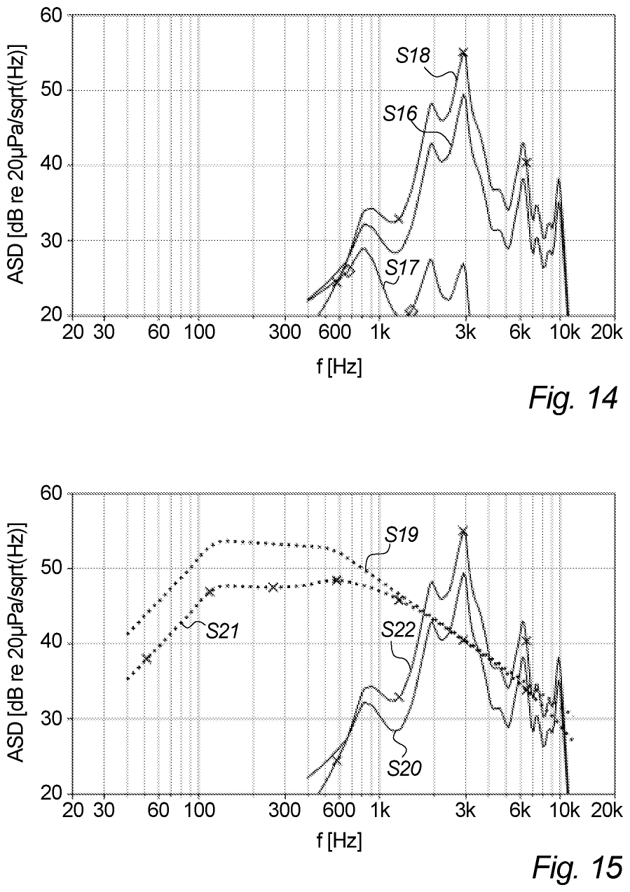

FIG. 14 is a graph also showing amplitude spectral density (ASD) as a function of frequency in the same way as the graph in FIG. 6. Specifically, the graph shows three signal curves S16, S17, and S18. The signal curve S16 corresponds to signal curve S3 in FIG. 6, and thus represents a short-time average spectrum of the consonant “t” produced by a speaker standing around 1 meter from the wearer of the in-ear headphone device 102. Signal curve S17 shows the effect of applying the vent transfer function T1 to the short-time average spectrum of the consonant “t”, and as seen in FIG. 14 the vent significantly attenuates the signal. This is not surprising when consulting the vent transfer function T1 which has a low-pass characteristic. Signal curve S18 shows the resulting consonant signal present in the ear canal of the user wearing the in-ear headphone device, and thereby represents contributions by the acoustic path and the electroacoustic path of the in-ear headphone device. In the present example, an amplification of consonants is achieved (as evident when comparing signal curve S18 with signal curve S16). Such amplification is advantageous in that it further improves speech intelligibility, as will be evident from the following figure.

FIG. 15 is a graph also showing amplitude spectral density (ASD) as a function of frequency in the same way as the graph in FIG. 6. Specifically, the graph shows four signal curves S19, S20, S21 and S22. Signal curve S19 corresponds to the babble noise signal also seen as signal curve S1 in FIG. 6, and signal curve S20 corresponds to the consonant signal also seen as signal curve S3 in FIG. 6. When directly comparing signal curves S19 and S20 it is seen that if the user is not wearing the in-ear headphone device of the speech intelligibility enhancing system, the low-frequency babble noise is present at a high level compared to the consonant “t”. The babble noise imposes a masking effect on the consonant “t” in this example. Note that this example only concerns the letter “t”, but a similar (and even more pronounced) effect is often present for other consonants. This makes speech comprehension particularly difficult, as the consonants produced by the speaker of interest are “drowned” by the babble noise present by the other people in the room. Signal curve S21 corresponds to signal curve S12 as seen in FIG. 12, and signal curve S22 corresponds to signal curve S18 in FIG. 14. Although the signal curves S19-S22 have effectively already been discussed in the preceding figures, an advantageous effect may first really be appreciated when they are directly compared as in FIG. 15. As seen Signal curve 21 is reduced compared to signal curve S19 in the low-frequency range of the spectrum, i.e., in a vowel dominated frequency range. Effectively, this shows that the electroacoustic path is arranged (by the specific transfer functions) in such a way that it compensates contributions from the acoustic path/vent in the vowel dominated frequency range, so that these contributions impart a lower masking effect on the consonants in the consonant dominated frequency range. Thereby, improved speech intelligibility is achieved. Thus, FIG. 15 shows that a signal-to-masking ration is improved by the electroacoustic path compensating contributions from the acoustic path in the vowel dominated frequency range.

FIG. 16 is a graph also showing amplitude spectral density (ASD) as a function of frequency in the same way as the graph in FIG. 6. Specifically, the graph shows four signal curves S23, S24, S25, and S26. Signal curve 23 corresponds to signal curve S1 (see FIG. 6), signal curve S24 corresponds to signal curve S2 (see also FIG. 6), signal curve S25 corresponds to signal curve S12 (see FIG. 12), and signal curve S26 corresponds to signal curve S15 (see FIG. 13). The FIGURE also reveals a beneficial effect concerning the long-time average spectrum of speech. If the in-ear headphone device 102 of the speech intelligibility enhancing system 101 is not used, the babble noise spectrum is above the long-time average spectrum of speech at high frequencies, such as frequencies in the range from 1 kHz to 6 kHz. However, when inserted in the ear canal, the speech intelligibility enhancing system 101 improves the speech-to-masker energy ratio, especially in the high-frequency range. This has the benefit that speech cues from the speaker of interest may be more easily detectable the user of the system and thereby positively impact speech intelligibility.

FIG. 17 illustrates an in-ear headphone device 102 of a speech intelligibility enhancing system according to an embodiment of the invention. The in-ear headphone device 102 is arranged to apply the transfer functions T1-T4 as illustrated in FIG. 7. Thereby, all results of signal processing as illustrated throughout FIGS. 6-16 are achievable by use of the in-ear headphone device 102. The in-ear headphone device of this embodiment comprises two microphones 103 arranged to record acoustic sound present in the external environment. The microphones of this embodiment are two omnidirectional microphones which are combined using a signal processor 104 to realize a desirable directional characteristic—however a dedicated directional microphone may also be employed according to another embodiment of the invention.

It should be noted that a speech intelligibility enhancing system 101 as mentioned in any of the preceding description may include two in-ear headphone devices 102; one in-ear headphone device 102 for each ear of the wearer of the speech intelligibility enhancing system.

### LIST OF REFERENCE SIGNS

101 Speech intelligibility enhancing system
102 In-ear headphone device
103 Microphone
104 Signal processor
105 Loudspeaker
106 Loudspeaker duct
107 Vent
108 External acoustic environment
109 Ear canal
110 Pinna (outer ear)
111 Flexible ear tip
201 Tympanic membrane (ear drum)
202 Vent element
203 Dampening element
204 Feedback microphone
501 Acoustic path
502 Electroacoustic path
503 Difference in sound pressure level
504 Center frequency of vowel dominated frequency range
505 Center frequency of consonant dominated frequency range
506 Resulting sound pressure level contributed by VDF
507 Resulting sound pressure level contributed by CDF
VDF Vowel dominated frequency range
CDF Consonant dominated frequency range
S1-S26 Signal curves
T1-T4 Transfer functions
P1-P4 Phase curves
D1-D4 Delay curves

1.-26. (canceled)

27. A speech intelligibility enhancing system for difficult acoustical conditions, the speech intelligibility enhancing system comprising:
at least one in-ear headphone device for insertion in an ear canal of a person, the at least one in-ear headphone device being arranged with an ear canal facing portion and an environment facing portion, and the at least one in-ear headphone device including:
an acoustic path comprising a vent, the acoustic path coupling the environment facing portion with the ear canal facing portion, and
an electroacoustic path comprising a microphone at the environment facing portion, a filter and a loudspeaker at the ear canal facing portion;
wherein the acoustic path is arranged to convey acoustic sound in a vowel dominated frequency range,
wherein the electroacoustic path is arranged to acoustically reproduce sound signals in a consonant dominated frequency range and in the vowel dominated frequency range, and
wherein the electroacoustic path is arranged such that a signal-to-masking ratio is improved by the electroacoustic path compensating contributions from the acoustic path in the vowel dominated frequency range.

28. The speech intelligibility enhancing system according to claim 27, wherein improving the signal-to-masking ratio includes increasing a resulting sound pressure level present in the consonant dominated frequency range with respect to the resulting sound pressure level present in the vowel dominated frequency range.

29. The speech intelligibility enhancing system according to claim 28, wherein the improving the signal-to-masking ratio includes reducing a difference between a resulting sound pressure level in the ear canal contributed by the vowel dominated frequency range and a resulting sound pressure level in the ear canal contributed by the consonant dominated frequency range by compensating contributions from the acoustic path in the vowel dominated frequency range using the electroacoustic path.

30. The speech intelligibility enhancing system according to claim 27, wherein the acoustic path is arranged with an acoustic transfer function having a low-pass characteristic with a pass-band and a cutoff frequency within a range from 250 Hz to 4 kHz,
wherein the vowel dominated frequency range includes frequencies below the cutoff frequency, and
wherein the consonant dominated frequency range includes frequencies above the cutoff frequency.

31. The speech intelligibility enhancing system according to claim 27, wherein the vowel dominated frequency range includes frequencies in a range from 50 Hz to 1 kHz, and
wherein the consonant dominated frequency range includes frequencies in a range from 2 kHz to 4 kHz.

32. The speech intelligibility enhancing system according to claim 29, wherein the difference is below 15 dB.

33. The speech intelligibility system according to claim 27, wherein the electroacoustic path is arranged to compensate contributions from the acoustic path in a signal processing frequency range of 300 Hz to 1 kHz.

34. The speech intelligibility enhancing system according to claim 27, wherein the compensation of contributions from the acoustic path is signal dependent.

35. The speech intelligibility enhancing system according to claim 27, wherein the compensation of contributions from the acoustic path is level dependent.

36. The speech intelligibility enhancing system according to claim 27, wherein the electroacoustic path is arranged to compensate contributions from the acoustic path by reproducing sound signals in at least a part of the vowel dominated frequency range.

37. The speech intelligibility enhancing system according to claim 36, wherein the electroacoustic path is arranged to reproduce sound signals in the at least part of the vowel dominated frequency range with a polarity opposite a polarity of the acoustic sound conveyed by the acoustic path.

38. The speech intelligibility enhancing system according to claim 36, wherein the electroacoustic path is arranged to reproduce sound signals in the at least part of the vowel dominated frequency range by applying a phase shift to sound signals.

39. The speech intelligibility enhancing system according to claim 27, wherein the loudspeaker and the vent are acoustically separated inside the at least one in-ear headphone device.

40. The speech intelligibility enhancing system according to claim 27, wherein the filter is arranged in a digital signal processor of the at least one in-ear headphone device.

41. The speech intelligibility enhancing system according to claim 27, wherein the at least one in-ear headphone device includes two in-ear headphone devices, one for each ear canal of the person, and wherein the two in-ear headphone devices are arranged to coordinate settings between them.

42. The speech intelligibility enhancing system according to claim 27, wherein the at least one in-ear headphone device includes a feedback microphone at the ear canal facing portion.

43. The speech intelligibility enhancing system according to claim 42, wherein the electroacoustic path is arranged to compensate contributions from the acoustic path based on input provided by the feedback microphone.

44. The speech intelligibility enhancing system according to claim 27, wherein the microphone of the electroacoustic path is a directional microphone.

45. The speech intelligibility enhancing system according to claim 27, wherein the electroacoustic path is arranged to amplify sound with a nominal gain in a passband of the electroacoustic path.

46. A method for enhancing speech intelligibility in difficult acoustical conditions, the method comprising steps of:
inserting at least one in-ear headphone device in an ear canal of a person, the at least one in-ear headphone device being arranged with an ear canal facing portion and an environment facing portion, the at least one in-ear headphone device comprising an acoustic path comprising a vent coupling the environment facing portion with the ear canal facing portion and an electroacoustic path comprising a microphone at the environment facing portion, a filter, and a loudspeaker at the ear canal facing portion;
conveying acoustic sound in a vowel dominated frequency range from the environment facing portion to the ear canal facing portion by the acoustic path;
acoustically reproducing sound signals in a consonant dominated frequency range and in the vowel dominated frequency range by the electroacoustic path; and
compensating contributions from the acoustic path in the vowel dominated frequency range by the electroacoustic path such that a signal-to-masking ratio is improved.
